(19) United States
(12) Patent Application Publication
(10) Pub. No.: US 2024/0417996 A1
(43) Pub. Date: Dec. 19, 2024

(54) ELONGATE MEMBERS, METHODS OF THEIR CONSTRUCTION AND APPARATUS THEREFOR

(71) Applicant: Gregory John NEIGHBOURS, Auckland (NZ)

(72) Inventor: Gregory John NEIGHBOURS, Auckland (NZ)

(21) Appl. No.: 18/712,483

(22) PCT Filed: Nov. 23, 2022
(86) PCT No.: PCT/IB2022/061312

§ 371 Date: May 22, 2024

(30) Foreign Application Priority Data
Nov. 23, 2021 (AU) 2021903770

(51) Int. Cl. E04H 12/34; E02D 27/42; E04C 3/22; E04H 12/12; F03D 13/10

(52) U.S. Cl. CPC E04H 12/341; E02D 27/425; E04C 3/22; E04H 12/12; E04H 12/342; F03D 13/112

(57) ABSTRACT

The present invention relates to an elongate member and methods of its formation and assembly, the elongate member constructed of a stacked sequence of adjacent sections, the elongate member comprising, at each interface of adjacent sections, a lower seat member of an upper more of said adjacent sections, and an upper seat member of a lower more of said adjacent sections, wherein said upper and lower seat members at each interface having been match-cast as a seat member pair and seated with each other in the same relative position as the relative position the seat member pair was match-cast in.

The present invention relates to elongate members and apparatus for and methods of their construction, for use in various structural applications such as but not limited to wind tower construction, tunnel or pipe construction.

### BACKGROUND

Towers, tunnels, columns and other elongate structures are commonly used in construction. For instance, tall concrete towers may be constructed using multiple pre-cast concrete members that are cast at ground level and then lifted into position with a crane or lifting device to be assembled to form an elongate member as the primary part of the tower. There are two popular design approaches in constructing a round concrete tower, a) one uses a series of stacked pre-cast concrete rings or cylinders, and b) another uses a series of pre-cast semi-circular segments that are assembled and stacked.

Whilst commonly such towers may be cylindrical and hence of parallel walls, tapered, semi-conical, frustoconical or parabolic walled towers, when taken in a vertical section, may also be constructed. When of changing geometrical shape along its height, dedicated formwork may be required for multiple precast elements of the tower. This may hence involve a large number of formwork sections for making pre-cast tower sections This can incur high costs.

The process of creating pre-cast concrete rings or cylinders may comprise vertical standing formwork that may define an inner mould and an outer mould between which a concrete slurry can be poured, to then set to define a hollow concrete ring or cylinder. Hydrostatic pressure accumulated during pouring of the slurry can be very large depending on the height of the pour. Such pressure may be resolved by using formwork ties or by bands around the outer mould using hoop tension. The inner mould may also be appropriately re-enforced to help resist the pressure generated by the poured concrete.

Taller concrete rings of cylinders are desirable to generate as it means that less units need to be manufactured and handled to assemble a tower of a given height, hence providing a construction cost saving. However, a disadvantage of tall vertically cast concrete rings or cylinders is that the formwork used to create such, needs to be designed to cope with high hydrostatic loads and this may come at a high cost. Installation of formwork ties made to help deal with the forces may result in high labour costs and may leave the wall of the ring or cylinder with formwork tie holes.

As well as hydrostatic pressure design parameters needing to be taken into account, handling and potentially transport of pre-cast components of a tower also create limitations on the size of the pre-cast ring, cylinder or segment to be created. Cranes may have a limited lifting capacity to handle the component of a tower being assembled and hence the total weight of a component may be limited by such factors. Whilst creating a tower from one pre-cast element may be feasible on paper, hydrostatic pressures, handling and transport limitations and construction costs may all play a role in the limits of what can or may desirably be done to create a tower or other elongate element such as pipes of tunnels of the like.

It is often also desirable to match-cast subsequent tubes so as to improve the subsequent assembly/stacking process. However, doing so brings rise to another disadvantage of these known methods of creating concrete rings or cylinders, aside from cost, labour and technical limitations, mentioned above, which is the time taken to assemble a complete series of match-cast tubes.

For instance, such methods involve casting of a first tube followed by subsequent assembly of a formwork atop of the first cast tube for casting of the next subsequent tube, with the interfacing joint match cast together. After the concrete has set, the second tube may be lifted down, separating the match cast interfaces. Further formwork is then set up on top of said second tube and a further third tube formwork is assembled. The third tube, once cast, is then lifted down and the same sequence of assembling formworks thereatop and pouring subsequent tubes is repeated until a sufficient number of tubes have been made.

Match casting tubes in this fashion is time-intensive, as it takes about 24 hours for the concrete to gain enough strength for it to be moved from its cast position. Thus, formation is restricted to about one tube per day. To construct enough tubes for, for example, a 150-meter-high tower requiring say 30 tubes of 5 meters height each, may thus take about a month to manufacture. Thus, the speed at which tubes can be match cast using this approach is limited to the time it takes for concrete to gain enough strength for the tube to be handled/lifted.

The formwork costs for a pre-cast semi-circular segment approach, may be lower than pre-cast rings or cylinders. However, the pre-cast semi-circular segments require grouted connections between each segment during tower assembly. This can be costly. A grouted connection may be established by a viscous settable liquid, typically cement-based, used to join two precast elements. Typically reinforcing is used within and spanning the joint to provide structural continuity between the precast elements. Having more parts required to assemble a tower adds to material and labour costs, including during construction.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

It is an object of at least preferred embodiments of the present invention to ameliorate at least some of the above-mentioned disadvantages of know methods of pre-cast tube or section formation and/or to at least provide the public with a useful alternative.

### SUMMARY OF THE INVENTION

In a first aspect of the present invention, there is provided an elongate member constructed from a stacked sequence of adjacent sections, the elongate member comprising:
at each interface of adjacent sections:
(a) a lower seat member of an upper more of said adjacent sections, and
(b) an upper seat member of a lower more of said adjacent sections,
said upper and lower seat members at each interface having been match-cast as a seat member pair and seated with each other in the same relative position as the relative position the seat member pair was match-cast in.

In a second aspect of the present invention, there is provided an elongate member constructed of a stacked sequence of adjacent sections, the elongate member comprising:
at each interface of adjacent sections:
(a) a lower seat member of an upper more of said adjacent sections, and
(b) an upper seat member of a lower more of said adjacent sections,
said upper and lower seat members at each interface, prior to being stacked, match-cast as a seat member pair and seated with each other in the same relative position as the relative position the seat member pair was match-cast in.

Preferably, each said section further comprises a segment intermediate of and spanning between its respective upper and lower seat members.

Preferably, the segment intermediate of each section is of a cast settable material.

Preferably, the segment intermediate of each section is of a cast settable material match cast with its respective upper and lower seat members.

Preferably, the segment of each section comprises of set concrete poured against and spanning between respective upper and lower seat members of said section.

Preferably, each seat member pair comprises a lower seat member and an upper seat member formed by casting the upper seat member of each seat member pair atop the lower seat member thereof by introducing settable material into a seat member formwork.

Preferably, each seat member pair comprises a lower seat member and an upper seat member formed by:
i. casting the lower seat member of each of the plurality of seat member pairs by introducing settable material into a seat member formwork,
ii. casting the upper seat member of each of each seat member pairs atop the cast lower seat member by introducing settable material into the seat member formwork.

Preferably, the match-cast faces of the upper and lower seat members of each seat member pair are formed at an interface therebetween so that the upper and lower seat members of each seat member pair can seat with each other in an abutting manner.

Preferably, the sections are so formed so as to have hollow cross sections.

Preferably, the sections are cylindrical and preferably tubular and hence generally circular in peripheral cross-sectional shape.

Preferably, the cast settable material comprises concrete.

Preferably, the cast settable material comprises high-slump or self-compacting concrete.

Preferably, the sections, intermediate segments thereof, and/or seat members thereof comprise hollow interiors so as to present generally annular peripheral cross-sectional shapes.

Preferably, a height of said sections is between about 2 meters and about 6 meters.

Preferably, a height of the upper seat member and/or lower seat member is between about 500 millimetres and 2 meters.

Preferably, a lateral span or diameter of the sections, intermediate segments thereof, and/or seat members thereof is between about 2 meters to about 6 meters.

Preferably, the lower seat member of each section comprises rebar extending upwardly therefrom into the intermediate segment and/or upper seat member of said section.

Preferably, the upper seat member of each section comprises holes arranged to receive said rebar.

Preferably, the upper seat member of each section comprises holes configured as a conduit for introduction of said cast settable material during formation of the lower seat member of the respective seat member pair and/or during formation of the intermediate segment of said section.

Preferably, the interface of the upper and lower seat members of each seat member pair are formed with castellations and corresponding apertures and/or tongues and corresponding groove formations at said match-cast faces of the seat members that are configured to cooperate with each other when said seat members seat with each other in an abutting manner.

In a second aspect of the present invention, there is provided an elongate tower assembled as a stack of a plurality of sections on top of each other, the tower comprising of at least two adjacent said sections that at their interface comprise of a first seat member of a first of said adjacent sections and a second seat member of a second of said adjacent sections, the first seat member and the second seat member at their interface having been match-cast as a seat member pair and seated with each other in the same relative position as the relative position the seat member pair was match-cast in.

Preferably, said first of said adjacent sections comprises, match cast against and projecting in the elongate direction from the first seat member, a cast intermediate segment.

Preferably, said second of said adjacent sections comprises, match cast against and projecting in the elongate direction from the second seat member, a cast intermediate segment.

Preferably, the sections are so formed so as to have hollow cross sections.

Preferably, the sections are cylindrical and preferably tubular and hence generally circular in peripheral cross-sectional shape.

Preferably, the cast settable material comprises concrete.

Preferably, the cast settable material comprises high-slump or self-compacting concrete.

Preferably, the sections, intermediate segments thereof, and/or seat members thereof comprise hollow interiors so as to present generally annular peripheral cross-sectional shapes.

Preferably, a height of said sections is between about 2 meters and about 6 meters.

Preferably, a height of the upper seat member and/or lower seat member is between about 500 millimetres and 2 meters.

Preferably, a lateral span or diameter of the sections, intermediate segments thereof, and/or seat members thereof is between about 2 meters to about 6 meters.

Preferably, the lower seat member of each section comprises rebar extending upwardly therefrom into the intermediate segment and/or upper seat member of said section.

Preferably, the upper seat member of each section comprises holes arranged to receive said rebar.

Preferably, the upper seat member of each section comprises holes configured as a conduit for introduction of said cast settable material during formation of the lower seat member of the respective seat member pair and/or during formation of the intermediate segment of said section.

Preferably, the interface of the upper and lower seat members of each seat member pair are formed with castellations and corresponding apertures and/or tongues and corresponding groove formations at said match-cast faces of the seat members that are configured to cooperate with each other when said seat members seat with each other in an abutting manner.

In a third aspect of the present invention, there is provided a method for assembling an elongate member (e.g. to for example define at least part of a tower or pipe or tunnel) of a plurality of sequentially ordered sections positioned in an abutting manner in the elongate direction of the elongate member, wherein the method comprises:
a. forming a plurality of seat member pairs each comprising a lower seat member and an upper seat member by:
   i. casting the upper seat member of each seat member pair atop the lower seat member thereof by introducing settable material into a seat member formwork, such that match-cast faces of the upper and lower seat members of each seat member pair are formed at an interface therebetween so that the upper and lower seat members of each seat member pair can seat with each other in an abutting manner,
b. separating the upper seat member of each seat member pair from the lower seat member thereof,
c. arranging a plurality of section formworks, where for each section formwork the upper seat member of a seat member pair is arranged at the bottom thereof and the lower seat member of a subsequent seat member pair is arranged at the top thereof,
d. casting an intermediate segment against and between the lower and upper seat members of each section formwork by introducing settable material therein, thereby forming the plurality of sequentially ordered sections,
e. arranging the sequentially ordered sections to define the elongate member, in sequence such that the match-cast faces of each of seat member pair are re-joined and seat with each other in an abutting manner to define said elongate member.

Preferably, the method also comprises casting the lower seat member of each of the plurality of seat member pairs by introducing settable material into said seat member formwork.

Preferably, the method also comprises immediately before step (i), casting the lower seat member of each of the plurality of seat member pairs by introducing settable material into said seat member formwork.

Preferably, the sections are so formed so as to have hollow cross sections.

Preferably, the sections are cylindrical and preferably tubular and hence generally circular in peripheral cross-sectional shape.

Preferably, the cast settable material comprises concrete.

Preferably, the cast settable material comprises high-slump or self-compacting concrete.

Preferably, the sections, intermediate segments thereof, and/or seat members thereof comprise hollow interiors so as to present generally annular peripheral cross-sectional shapes.

Preferably, a height of said sections is between about 2 meters and about 6 meters.

Preferably, a height of the upper seat member and/or lower seat member is between about 500 millimetres and 2 meters.

Preferably, a lateral span or diameter of the sections, intermediate segments thereof, and/or seat members thereof is between about 2 meters to about 6 meters.

Preferably, the lower seat member of each section comprises rebar extending upwardly therefrom into the intermediate segment and/or upper seat member of said section.

Preferably, the upper seat member of each section comprises holes arranged to receive said rebar.

Preferably, the upper seat member of each section comprises holes configured as a conduit for introduction of said cast settable material during formation of the lower seat member of the respective seat member pair and/or during formation of the intermediate segment of said section.

Preferably, the interface of the upper and lower seat members of each seat member pair are formed with castellations and corresponding apertures and/or tongues and corresponding groove formations at said match-cast faces of the seat members that are configured to cooperate with each other when said seat members seat with each other in an abutting manner.

In a fourth aspect of the present invention, there is provided a method for assembling an elongate member (e.g. to for example define at least part of a tower or pipe or tunnel) from a plurality of sequentially ordered sections positioned in an abutting manner in the elongate direction of the elongate member, wherein the method comprises:
a. providing a plurality of seat member pairs each comprising a lower seat member and an upper seat member comprising match-cast surfaces at an interface therebetween to seat with each other in an abutting manner,
b. arranging a plurality of section formworks, where for each section formwork the upper seat member of a seat member pair is arranged at the bottom thereof and the lower seat member of a subsequent seat member pair is arranged at the top thereof,
c. casting an intermediate segment against and between the lower and upper seat members of each section formwork by introducing settable material therein, thereby forming the series of sequentially ordered sections,
d. arranging the sequentially ordered match-cast sections to define the elongate member, in a sequentially ordered sequence such that the match-cast surfaces of each of the plurality of seat member pairs are re-joined and seat with each other in an abutting manner to define said elongate member.

Preferably, the sections are so formed so as to have hollow cross sections.

Preferably, the sections are cylindrical and preferably tubular and hence generally circular in peripheral cross-sectional shape.

Preferably, the cast settable material comprises concrete.

Preferably, the cast settable material comprises high-slump or self-compacting concrete.

Preferably, the sections, intermediate segments thereof, and/or seat members thereof comprise hollow interiors so as to present generally annular peripheral cross-sectional shapes.

Preferably, a height of said sections is between about 2 meters and about 6 meters.

Preferably, a height of the upper seat member and/or lower seat member is between about 500 millimetres and 2 meters.

Preferably, a lateral span or diameter of the sections, intermediate segments thereof, and/or seat members thereof is between about 2 meters to about 6 meters.

Preferably, the lower seat member of each section comprises rebar extending upwardly therefrom into the intermediate segment and/or upper seat member of said section.

Preferably, the upper seat member of each section comprises holes arranged to receive said rebar.

Preferably, the upper seat member of each section comprises holes configured as a conduit for introduction of said cast settable material during formation of the lower seat member of the respective seat member pair and/or during formation of the intermediate segment of said section.

Preferably, the interface of the upper and lower seat members of each seat member pair are formed with castellations and corresponding apertures and/or tongues and corresponding groove formations at said match-cast faces of the seat members that are configured to cooperate with each other when said seat members seat with each other in an abutting manner.

In a fifth aspect of the present invention, there is provided a section of or for an elongate member (e.g. to for example define at least part of a tower or pipe or tunnel) constructed from a sequentially ordered series of said sections positioned in an abutting manner in the elongate direction of the elongate member, said section comprising:
an intermediate segment formed by introducing a settable material into a void of a section formwork defined between a lower seat member and an upper seat member arranged within and/or at opposed ends of said section formwork, the seat members forming part of the section once said intermediate segment is set,
wherein the lower and upper seat members each comprise outwardly facing match-cast surfaces configured to seat in an abutting manner with corresponding outwardly facing match-cast surfaces of the seat members of another section or sections of said series of sections, said outwardly facing match-cast surfaces thereby defining opposing ends of the section so as to permit its sequential abutment with another section or sections of said series of sections.

Preferably, the sections are so formed so as to have hollow cross sections.

Preferably, the sections are cylindrical and preferably tubular and hence generally circular in peripheral cross-sectional shape.

Preferably, the cast settable material comprises concrete.

Preferably, the cast settable material comprises high-slump or self-compacting concrete.

Preferably, the sections, intermediate segments thereof, and/or seat members thereof comprise hollow interiors so as to present generally annular peripheral cross-sectional shapes.

Preferably, a height of said sections is between about 2 meters and about 6 meters.

Preferably, a height of the upper seat member and/or lower seat member is between about 500 millimetres and 2 meters.

Preferably, a lateral span or diameter of the sections, intermediate segments thereof, and/or seat members thereof is between about 2 meters to about 6 meters.

Preferably, the lower seat member of each section comprises rebar extending upwardly therefrom into the intermediate segment and/or upper seat member of said section.

Preferably, the upper seat member of each section comprises holes arranged to receive said rebar.

Preferably, the upper seat member of each section comprises holes configured as a conduit for introduction of said cast settable material during formation of the lower seat member of the respective seat member pair and/or during formation of the intermediate segment of said section.

Preferably, the interface of the upper and lower seat members of each seat member pair are formed with castellations and corresponding apertures and/or tongues and corresponding groove formations at said match-cast faces of the seat members that are configured to cooperate with each other when said seat members seat with each other in an abutting manner.

In a sixth aspect of the present invention, there is provided a method of casting a plurality of seat member pairs each comprising a lower seat member and an upper seat member for assembling an elongate member of a plurality of sequentially ordered sections positioned in an abutting manner in the elongate direction of the elongate member, wherein the method comprises by:
i. casting the lower seat member of each of the plurality of seat member pairs by introducing settable material into a seat member formwork,
ii. casting the upper seat member of each of each seat member pairs atop the cast lower seat member by introducing settable material into the seat member formwork, such that match-cast faces of the upper and lower seat members of each seat member pair are formed at an interface therebetween so that the upper and lower seat members of each seat member pair can seat with each other in an abutting manner.

Preferably, the method further comprises separating the upper seat member from the lower seat member of each cast seat member pair.

Preferably, the sections are so formed so as to have hollow cross sections.

Preferably, the sections are cylindrical and preferably tubular and hence generally circular in peripheral cross-sectional shape.

Preferably, the cast settable material comprises concrete.

Preferably, the cast settable material comprises high-slump or self-compacting concrete.

Preferably, the sections, intermediate segments thereof, and/or seat members thereof comprise hollow interiors so as to present generally annular peripheral cross-sectional shapes.

Preferably, a height of said sections is between about 2 meters and about 6 meters.

Preferably, a height of the upper seat member and/or lower seat member is between about 500 millimetres and 2 meters.

Preferably, a lateral span or diameter of the sections, intermediate segments thereof, and/or seat members thereof is between about 2 meters to about 6 meters.

Preferably a lower most of said sections of the stack defining at least part and preferably a substantial part of a wind tower, is supported on a foundation.

Preferably the foundation is a concrete pad or block.

Preferably, the lower seat member of each section comprises rebar extending upwardly therefrom into the intermediate segment and/or upper seat member of said section.

Preferably, the upper seat member of each section comprises holes arranged to receive said rebar.

Preferably, the upper seat member of each section comprises holes configured as a conduit for introduction of said cast settable material during formation of the lower seat member of the respective seat member pair and/or during formation of the intermediate segment of said section.

Preferably, the interface of the upper and lower seat members of each seat member pair are formed with castellations and corresponding apertures and/or tongues and corresponding groove formations at said match-cast faces of the seat members that are configured to cooperate with each other when said seat members seat with each other in an abutting manner.

In a seventh aspect of the present invention, there is provided a method of constructing an elongate member from a plurality of abutting sections, the method comprising:
a. forming a first seat member by casting a settable material against a second seat member to, at the interface of the first seat member and second seat member, define a match-cast surface of each of said first seat member and second seat member, and
b. forming a first of said sections by match casting against and projecting in the elongate direction away from the first seat member, a first section segment using a settable material, with the match cast surface of said first seat member presented at a first end of said first section, and
c. forming a second of said sections by match casting against and projecting in the elongate direction away from the second seat member, a second section segment using a settable material, with the match cast surface of said second seat member presented at a first end of said second section,
d. stacking the first section against the second section with the match cast surface of the first seat member abutting the match cast surface of the second seat member.

Preferably, the first seat member is formed by casting a settable material on top of the second seat.

Preferably, the first of said sections is formed, by match casting on top and projecting upwardly and in the elongate direction away from the first seat member, a first section segment using a settable material, with the match cast surface of said first seat member presented at the first end, being the bottom end, of said first section.

Preferably, the second of said sections is formed, by match casting on top and projecting upwardly and in the elongate direction away from the second seat member, a second section segment using a settable material, with the match cast surface of said second seat member presented at the first end, being the bottom end, of said second section.

Preferably, the second of said sections is formed, by match casting against and projecting downwardly and in the elongate direction away from the second seat member, a second section segment using a settable material, with the match cast surface of said second seat member presented at the first end, being the top end, of said second section.

Preferably, the stacking occurs in a vertical direction.

Preferably, the sections are so formed so as to have hollow cross sections.

Preferably, the sections are cylindrical and preferably tubular and hence generally circular in peripheral cross-sectional shape.

Preferably, the cast settable material comprises concrete.

Preferably, the cast settable material comprises high-slump or self-compacting concrete.

Preferably, the sections, intermediate segments thereof, and/or seat members thereof comprise hollow interiors so as to present generally annular peripheral cross-sectional shapes.

Preferably, a height of said section(s) is between about 2 meters and about 6 meters.

Preferably, a height of the upper seat member and/or lower seat member is between about 500 millimetres and 2 meters.

Preferably, a lateral span or diameter of the sections, intermediate segments thereof, and/or seat members thereof is between about 2 meters to about 10 meters.

Preferably, the lower seat member of each section comprises rebar extending upwardly therefrom into the intermediate segment and/or upper seat member of said section.

Preferably, the upper seat member of each section comprises holes arranged to receive said rebar.

Preferably, the upper seat member of each section comprises holes configured as a conduit for introduction of said cast settable material during formation of the lower seat member of the respective seat member pair and/or during formation of the intermediate segment of said section.

Preferably, the interface of the upper and lower seat members of each seat member pair are formed with castellations and corresponding apertures and/or tongues and corresponding groove formations at said match-cast faces of the seat members that are configured to cooperate with each other when said seat members seat with each other in an abutting manner.

In a further aspect the present invention may be said to be a tower constructed from a plurality of sections that have been stacked on on top of the other, wherein at the interface of each section match cast seat members abut each other in the same relative orientation as how they were match cast prior.

Preferably the sections are as herein before described.

Preferably the seat members are as herein before described.

Preferably the plurality of sections have been stacked on on top of the other to a height greater than 30 m and preferably greater than 60 m and preferably greater than 80 m.

In a further aspect the present invention may be said to be a tower constructed from a plurality of said sections as herein before described.

Preferably the stack is vertical.

Preferably the stack is horizontal.

Preferably the stack is straight.

Preferably the stack is curved (such as in the form of a tunnel or pipe).

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 shows a perspective view of an embodiment elongate member formed by successive abutment of sequentially ordered sections.

FIG. 2A shows a perspective exploded view of an embodiment section formed from the methods and apparatus described herein.

FIG. 2B shows a perspective exploded view of another embodiment section formed from the methods and apparatus described herein.

FIG. 3A shows a cross-sectional side view of an embodiment seat member formwork.

FIG. 3B shows a cross-sectional side view of an embodiment seat member formwork with the lower seat member cast therein.

FIG. 3C shows a cross-sectional side view of an embodiment seat member formwork with the lower and upper seat members cast therein.

FIG. 4A shows a cross-sectional side view of two embodiment seat member formworks with seat member pairs formed therein.

FIG. 4B shows a cross-sectional side view of the lower seat members of the seat member pairs of FIG. 4A rearranged atop levels.

FIG. 4C shows a cross-sectional side view of two section formworks with two sections formed therein having the lower seat members of FIG. 4B.

FIG. 4D shows a cross-sectional side view of the two completed sections of FIG. 4C being raised for abutment theretogether.

FIG. 5A shows a cross-sectional side view of an inner form work of an embodiment section formwork arranged atop levels.

FIG. 5B shows a cross-sectional side view of an outer form work of the embodiment section formwork of FIG. 5A positioned therein.

FIG. 5C shows a cross-sectional side view of intermediate segment limits of the embodiment section formwork of FIG. 5B positioned therein.

FIG. 5D shows a detailed cross-sectional side view of part of the embodiment section formwork of FIG. 5C.

FIG. 5E shows a cross-sectional side view of the embodiment section formwork of FIG. 5D completely assembled.

FIG. 5F shows a cross-sectional side view of the embodiment section formwork of FIG. 5E disassembled with a completed section remaining.

FIG. 6A shows a cross-sectional side view of inner and outer formworks of an embodiment seat member formwork being repurposed as the inner and outer formworks of an embodiment section formwork.

FIG. 6B shows a side view of an embodiment seat member pair having castellations and apertures about its interface.

FIG. 6C shows a cross-sectional side view of an embodiment seat member pair having a tongue and groove configuration about its interface positioned within an embodiment seat member formwork.

### DETAILED DESCRIPTION

The present invention relates to elongate members, methods and associated apparatus for forming elongate members, using a settable material such as concrete.

An elongate member according to an example of the present invention may be formed solid or hollow in cross section, either of a straight or at least partially non straight longitudinal configuration. When hollow it may define a passage in the elongate direction therethrough. In a preferred form the elongate member is cylindrical and preferably tubular and hence generally circular in peripheral cross-sectional shape. However, it may be of other shape such as prismatic (e.g. being polygonal in cross section such as triangular, square, hexagonal or octagonal, for example) and have a corresponding or otherwise non-corresponding polygonal, triangular, hexagonal or octagonal internal peripheral cross sectional shape.

Preferably the elongate member is hollow of a substantially cylindrical or tapered circular peripheral shape. It is preferably made by using a settable material in a cast manner. The settable material may hence be a castable settable material such as pourable concrete. Before setting the settable material is fluid to allow it to be poured.

In a preferred form the elongate member may be defined by multiple sections. The sections may have a length-wise direction to be parallel the elongate axis when assembled as part of the elongate member. At the end of the length of a section are its opposed ends that may be defined by at least one outwardly facing surface as will herein after be described.

Since the sections are arranged to define the elongate member, they may also each be cylindrical and preferably tubular and hence generally circular in peripheral cross-sectional shape as the case may be. However, each section may be of other shape such as prismatic (e.g. being polygonal in cross section such as triangular, square, hexagonal or octagonal, for example) and have a corresponding or otherwise non-corresponding polygonal, triangular, hexagonal or octagonal internal peripheral cross sectional shape. Such sections are also preferably hollow and have a passage passing there through and through its opposed ends. The sections of an elongate member may not all be identical. For example if the elongate member is to define a tower for a wind power generator, the tower may be tapered and hence sections higher up may be of a smaller diameter than those at or near the base of the tower.

The sections may be formed concurrently and may be formed separately as will herein be described. The sections may be formed as unitary items in a formwork and then assembled into an elongate member.

Examples of structures which may be constructed using an elongate member that may be formed from the said methods and apparatuses described herein, include but are not limited to tower structures, such as on-shore or off-shore marine tower structures, including those that may be used as wind power generator towers, tower structures for buildings or high-rises or the like, pipes, lengths of underground tunnel structures (i.e., road vehicle transport tunnels), partially or fully submerged marine support structures such as pier columns, or supporting columns and structures in general for the construction of buildings or high-rises of various kinds. As a tunnel or a pipe the passage defined through said elongate member may provide a transport conduit and location for utilities. As a tower the passage defined through said elongate member may provide an access passage and location for utilities.

Therefore, whilst the examples provided herein refer largely to elongate members and their formation for the use in towers such as wind power generator towers that may be used for onshore or off-shore installs, and while some benefits described herein arise in particular when said methods are employed in said construction of wind towers, those skilled in the art will appreciate that the disclosures may be applied equally to the construction of a wide variety of structures, and that many of the benefits or advantages described herein in relation to wind tower construction may equally apply a wide variety of structures as well.

Thus, when the term tower is used throughout this specification, it refers to an elongate portion of a tower, where any functions and features thereof, as well as any methods or means of formation, construction and assembly, being applicable to elongate members in any other applications, such as those herein described. The terms tower and elongate member may hence be used interchangeably throughout this section of the specification.

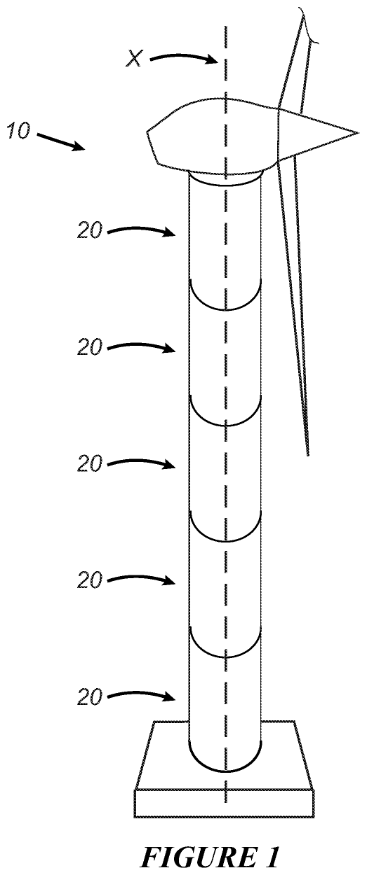

An example of such an elongate member 10 is shown in FIG. 1, wherein it forms the tower 10 of a wind turbine installation, as shown. The tower 10 comprises a plurality of sequentially ordered sections 20 positioned in an abutting manner in the elongate direction X of the elongate member 10 or tower 10. Reference herein made to elongate axis or direction, whether of the elongate member/tower 10, or the sections 20 that comprise it, refers to the longitudinal direction or axis extending substantially centrally through the length of the elongate member 10 or sections 20 thereof. In some applications, such as the wind tower 10 of FIG. 1, this elongate axis or direction X is oriented vertically in accordance with the upright orientation of the corresponding elongate member 10 once installed/positioned in-situ. However, in other applications, such as those of a tunnel or pipe described above, said elongate axis or direction X may be oriented horizontally in accordance with the horizontal orientation of the corresponding elongate member 10 once installed/positioned in-situ. It will of course be appreciated that some applications will necessitate in-situ installed orientations of an elongate member 10 that are not substantially vertical or horizontal, but somewhere therebetween, i.e., angled elongate members 10 forming part of a tunnel/pipe incline, and the like.

In any case, irrespective of the in-situ orientation of the elongate member 10 once installed/positioned, the sections 20 thereof are formed by the methods and apparatus described herein in a vertical orientation i.e., the elongate direction X of sections 20 shown in FIGS. 1 to 6C is shown to be vertical such that the sections 20 extend longitudinally in the vertical direction. In some instances, sections 20 shown and/or described herein may not be ‘elongate’ in and of themselves (i.e., they may be of a low aspect ratio having a height less than or equal to cross-sectional span/diameter), nonetheless, the elongate axes X thereof will extend along said sections 20 in a manner corresponding to the longitudinal/elongate direction of the eventual elongate members 10 they go onto form part of.

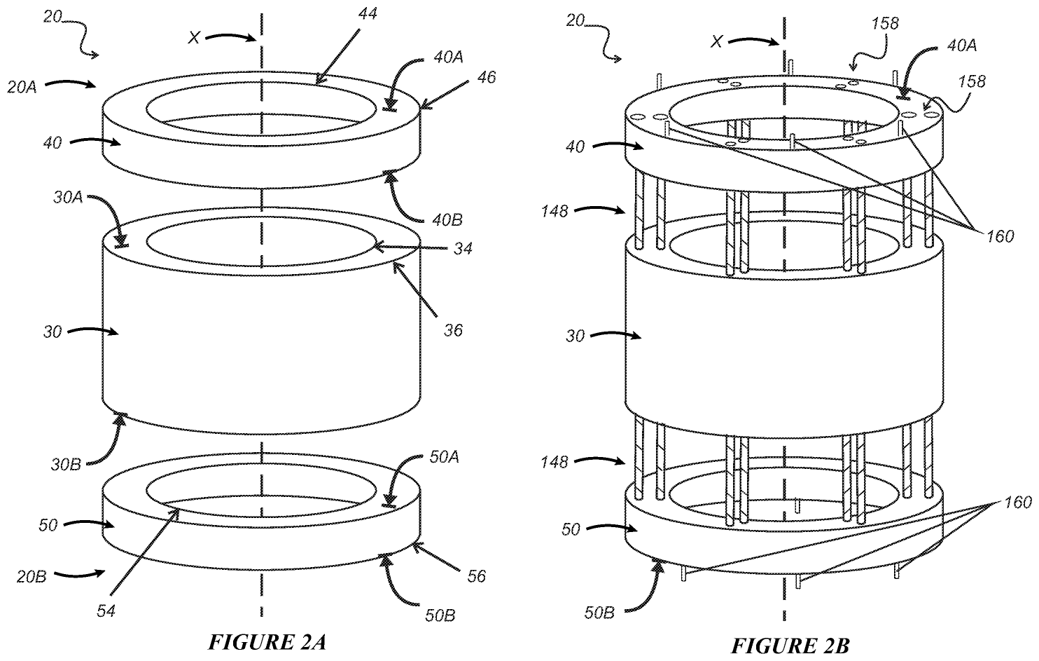

An example section 20 is shown in FIG. 2A. Here, the section 20 and its elongate axis X is, as stated above, oriented vertically. Terms such as ‘upper’, ‘lower’, ‘higher’, ‘central’ etc. may be used herein in reference to aspects of a section 20 to merely indicate their relative vertical positions in the vertical orientation of sections 20 or their components during formation thereof. However, these terms should only be construed in an explanatory manner and may or may not represent the relative vertical positions of aspects of a section 20 during assembly, or once assembled/installed as part of the larger elongate member 10.

The section 20 is shown in FIG. 2A in an exploded configuration for ease of reference and may comprise principally of a central intermediate segment 30 with an upper seat member 40 thereabove and a lower seat member 50 therebelow. The section 20, and these components thereof, are shown taking a substantially tubular configuration in FIGS. 1 to 6C (i.e., cylindrical with a corresponding internal hollow passage therethrough, corresponding with the exemplary embodiment throughout this specification of an elongate member 10 used as part of a wind tower).

However, depending on the desired form of the elongate member 10, as explained above, the section 20 may instead take various other forms, such as prismatic (e.g. being polygonal in cross section such as triangular, square, hexagonal or octagonal, for example) and have a corresponding or otherwise non-corresponding polygonal, triangular, hexagonal or octagonal internal peripheral cross sectional shape/hollow passage. Some elongate member 10 applications may or may not necessitate a hollow internal passage and/or may or may not be tapered lengthwise and thus necessitate sections 20 being likewise tapered along their vertical lengths, with or without internal hollow passages. Further, some sections 20 may have internal peripheral cross sectional shapes/hollow passages that are shaped differently/do not correspond to their external peripheral cross sectional shapes. It is envisaged that more than one hollow passage may be provided.

In any case, the central intermediate segment 30, upper seat member 40 and lower seat member 50 of sections 20 shown in FIGS. 1 to 6C preferably have a longitudinally consistent (non-tapered) substantially tubular/cylindrical configuration, where the intermediate segment outer periphery 32, upper seat member outer periphery 42 and lower seat member outer periphery 52 are preferably equal in diameter, as preferably are the intermediate segment inner periphery 34, upper seat member inner periphery 44 and lower seat member inner periphery 54.

The intermediate segment 30 has an upper face 30A and lower face 30B, defining the planar surfaces on opposite ends of the intermediate segment 30. The upper face 30A is configured to abut and cooperate with the lower face 40B of the upper seat member 40, and the lower face 30B is configured to abut and cooperate with the upper face 50A of the lower seat member 50. The seat members 40, 50 also have upper and lower faces 40A and 50B, respectively defining outwardly facing match-cast surfaces thereof, i.e., the upper seat member 40 has upper face 40A that will hereinafter be referred to as the upper match-cast surface 40A thereof; and the lower seat member 50 has lower face 50B that will hereinafter be referred to as the lower match-cast surface 50B thereof. These match-cast surfaces 40A, 50B are outwardly facing in the sense that they define opposing ends of the section 20 (‘upper’ opposite end 20A and ‘lower’ opposite end 20B).

The intermediate segment 30 is preferably formed, as will hereinafter be described in further detail, by introducing a settable material into a void 202 of a section formwork 200 defined between the lower seat member 50 and the upper seat member 40 arranged within such a section formwork 200, the seat members 40, 50 thereby forming part of the section 20 once said intermediate segment 30 is set. Further, the outwardly facing match-cast surfaces 40A, 50B of the seat members 40, 50 are configured to seat in an abutting manner with corresponding outwardly facing match-cast surfaces of the seat members of another section or sections of a series of sections forming an elongate member 10. In this way, the outwardly facing match-cast surfaces 40A, 50B define opposing ends 20A, 20B of the section 20 so as to permit its sequential abutment with another section or sections of said series of sections.

The seat members 40, 50 themselves are formed, as will hereinafter also be described in further detail, by introducing a settable material into a seat member formwork 100 to thereby form a seat member pair 101, where such formation also occurs vertically, with an ‘upper’ seat member 140 and ‘lower’ seat member 150.

However, the seat members 40, 50 of any given section 20 are not formed together, instead, they are derived from two different and match cast seat member pairs 101 that are split/separated after being match cast together. Thus, the lower seat member 50 of a section 20 is actually derived from the upper seat member 140 of a first seat member pair 101A, and the upper seat member 40 of a section 20 is actually derived from the lower seat member 150 of a second seat member pair 101B.

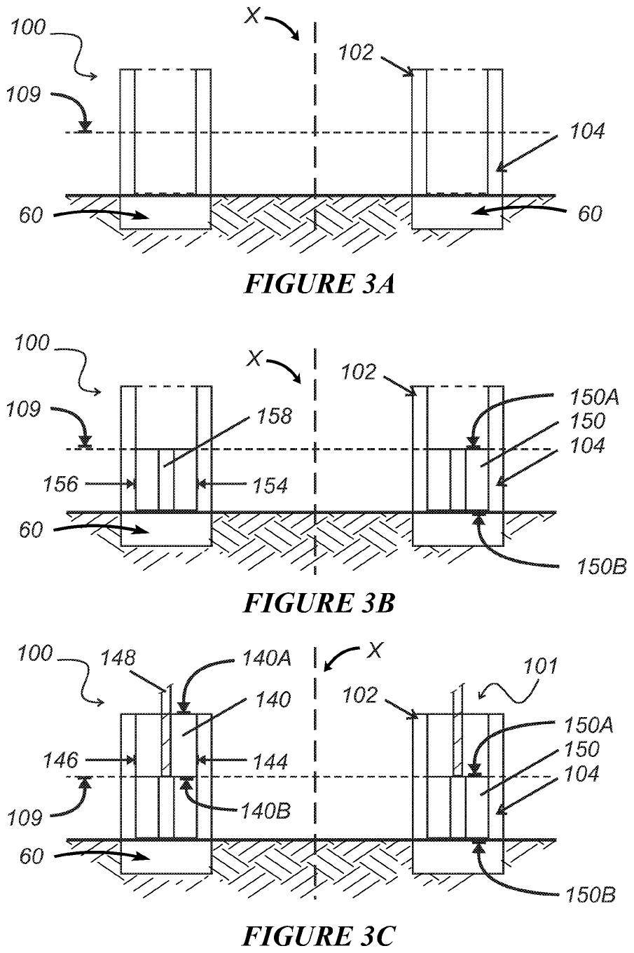

This will be clarified with reference to the formation method of the seat members pairs 101, as shown in FIGS. 3A to 3B. Here, cross-sectional views are shown of the seat member formwork 100 during the formation process, where the section is taken through a vertical plane extending substantially along the elongate axis X.

Thus, FIG. 3A shows the seat member formwork 100 prior to any settable material being introduced therein, where there is shown an inner formwork member 102 and outer formwork member 104, both being substantially cylindrical/tubular annular members defining the inner and outer peripheries 144, 146, 154, 156 of the seat members that will be formed therebetween. It will be appreciated that these inner and outer formwork members 102, 104 may be otherwise shaped/configured depending on the desired inner and outer cross-sectional shapes/diameters/tapers and the like of the seat members to be formed therefrom.

The inner and outer formwork members 102, 104 are shown positioned atop formwork levels 60, that are configured to provide the truest possible level for subsequent formation of the seat member pairs 101. Also shown in FIG. 3A is an interface 109 that defines the notional plane of abutment between the lower seat member 150 and upper seat member 140 of the seat member pair 101 that will be formed within the seat member formwork 100 by introduction of settable material therein.

Settable material as referenced herein may be a castable settable material such as pourable concrete, preferably being fluidic to allow it to be introduced by pouring, injection/pumping or any other means known in the art of propelling or otherwise introducing such settable material. A preferred type of concrete to be used is “High Slump” or self-compacting concrete. Self-compacting concrete is very transportable pre-curing and will find its own level when pumped into the formworks 100, 200 described herein.

During casting, the outer formwork 104 supports the cast pressure as a first load of settable material is poured into the void to form the first, or bottom-most lower seat member 150. Once that seat member 150 has sufficiently cured and acquired sufficient strength, as shown in FIG. 3B, a release agent may be applied to the ‘top’ surface (corresponding face 150A) of the seat member 150, following which more settable material may be poured into said void for formation of the second seat member 140 on top of it, as shown in FIG. 3C. The release agent prevents the two seat members 140, 150 from sticking or bonding together with the lower seat member 150 acting as a ‘pro-former’ to the second seat member 140 poured there-against, thus creating a match-cast fit along the interface 109.

This match-cast fit provides the outwardly facing match-cast surfaces 140B, 150A of the seat members 140, 150 that allow them to seat in an abutting manner with one another. Once the seat members 140, 150 are formed and set, they can be split up, with the upper seat member 140 being used to form the ‘lower’ seat member 50 of a first section 20 (thereby defining lower opposing end 20B thereof), and the lower seat member 150 being used to form the ‘upper’ seat member 40 of a second section 20 (thereby defining upper opposing end 20A thereof). Those sections, once formed, then being couplable together by assembly of the first section atop of the second section (in the case of an in-situ vertically oriented elongate member 10), such that match-cast surface 140B correspondingly matches, couples and connects to the match-cast surface 150A.

In this way, this matching cast fit along interface 109 during cast of a seat member pair 101 provides the above-mentioned benefit of easily coupling together successive sections 20 when assembling a larger elongate member 10 or portion thereof (i.e., permitting sequential abutment of one section with another section or sections of a series of sections). In this manner, one may consider the upper seat member's match-cast surface 140B of a given seat member pair 101 as being a ‘negative’ of the lower member's match-cast surface 150A of that same seat member pair 101 being the ‘positive’. Their eventual re-joining after forming part of two different sections (i.e., after going to define opposing upper and lower ends 20A, 20B of two different sections) thereby bringing their ‘negative’ and ‘positive’ ‘polarities’ back together and thus also enabling effective load transfer therebetween.

Shown extending up from the upper seat member 140 in FIG. 3C is reinforcing bars 148, or rebar, extending from a location near the match-cast surface 140B of the seat member 140 and out through the upper face 140 thereof. These rebars 148 can be used to reinforce or strengthen the seat members and may also help to increase tensile resilience of the sections 20 overall, since the rebars 148 will extend into the area of the sections section formworks where the intermediate segment 30 will be cast and thus where settable material will be poured around the rebars 148.

Since casting of said seat members occurs on preferably a horizontal surface, holes 158 are also shown extending through the lower seat member 150. Since the lower seat members 150, once split up from their respective seat member pairs 101, will be placed as the upper seat members 40 within a section formwork 200 with the upper seat members 140 placed as lower seat members 50 within a section formwork 200, the rebars 148 of said upper seat members 140 (lower seat members 50 once within a section formwork 200) may extend upwardly through the holes 158 of the lower seat members 150 (upper seat members 40 once within a section formwork 200). In this way, the positioning of the holes 158 and rebars 148 may be configured appropriately to correspond to one another.

The holes 158 may also be used for introduction of settable material therethrough once the lower seat members 150 are placed as the upper seat members 40 within a section formwork 200, said settable material being poured/injected/pumped or otherwise introduced through said holes 158 down into the void of the section formworks 200 to form the intermediate segment 30 of a section 20, as will be described in further detail below.

Rebars 148 may be composed from steel dowels, or other know suitable metals, metal-alloys or materials having tensile capacity which compliments the compressive capacity of cast concrete and the like. In some embodiments, it may be desirable that the rebar 148 comprise corrugated bars (and/or dowels having corrugated sleeves), and that the holes 158 are sized larger than the rebars 148 (larger diameters), such that settable material, once the void of the section formwork 200 is filled (i.e., the intermediate segment 30 fully ‘poured’) rises up through the hole to surround the rebar 148 and engage/set into the rebar 148 corrugations, further improving resilience and overall integrity of a completed/formed section 20.

It will be appreciated that in some embodiments, the upper seat member 140 may be formed with a plurality of rebars 148 (i.e., arranged circumferentially between its inner and outer peripheries 144, 146), and consequently, a plurality of holes 158 may be required for the lower seat member 150 (i.e., likewise arranged circumferentially between its inner and outer peripheries 154, 156). This is shown in FIG. 2B, where, once the upper seat member 140 is positioned as part of a section as a lower seat member 50 and the lower seat member 150 is positioned as part of a section as an upper seat member 40, a plurality of rebar 148 and plurality of holes 158 are consequently required. It will be noted that FIG. 2B is an exploded view of an embodiment section 20 having such a configuration and thus the rebars 148 are shown for illustrative purposes only and may not necessarily have a length/height as shown. Further, while only vertically oriented rebar 148 are shown in FIG. 2B and elsewhere, it will be appreciated that horizontally oriented rebar may also be provided extending circumferentially (i.e., annular rings of rebar) at various points along the height of the vertical rebars 148, thereby forming a reinforcing cage.

FIG. 2B also shows that seat members 40, 50 may be formed with alignment guides or pins 160 that extend from the match-cast surfaces 40A, 50B to interface with corresponding receptacles formed on the corresponding match-case surfaces of the other seat members they are formed with. These alignment guides or pins 160 can assist in facsimile alignment of sections 20 when moving them into an abutting manner during assembly of an elongate member 10.

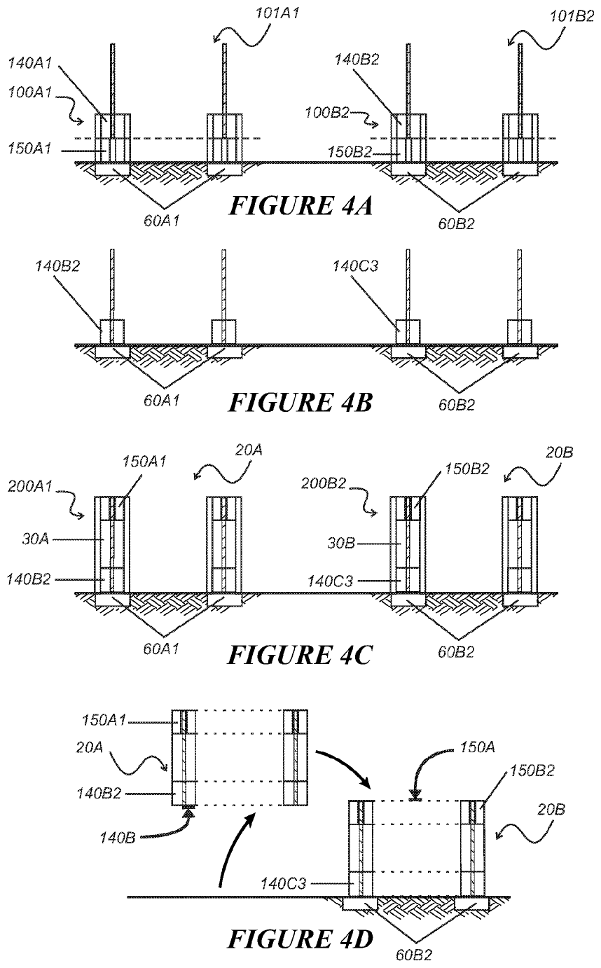

The process of forming said section 20 will now be described with reference to FIGS. 4A to 4D. Here, two seat member pairs 101A1, 101A2 are shown being formed into two sections 20A, 20B, for illustrative purposes. However, as will hereinafter be described, this process may occur with the simultaneous advantageous formation of many seat member pairs and many sections 20.

In FIG. 4A a first seat member pair 101A1 has been formed on the left having an upper seat member 140A1 and a lower seat member 150A1. Likewise, a second seat member pair 101B2 has been formed on the right having an upper seat member 140A2 and a lower seat member 140B2.

In FIG. 4B the respective formworks 100A1 and 100B2 of the seat member pairs 101A1 and 101B2 are disassembled/removed and the respective seat member pairs 101A1 and 101B2 split, with the upper seat member 140B2 of the right-side second seat member pair 101B2 placed on the left-side levels 60A1. Meanwhile, on the levels 60B2 of the right-side seat member pair 101B2, the upper seat member 140C3 of another seat member pair (formation of which is not shown in FIG. 4A) has been placed.

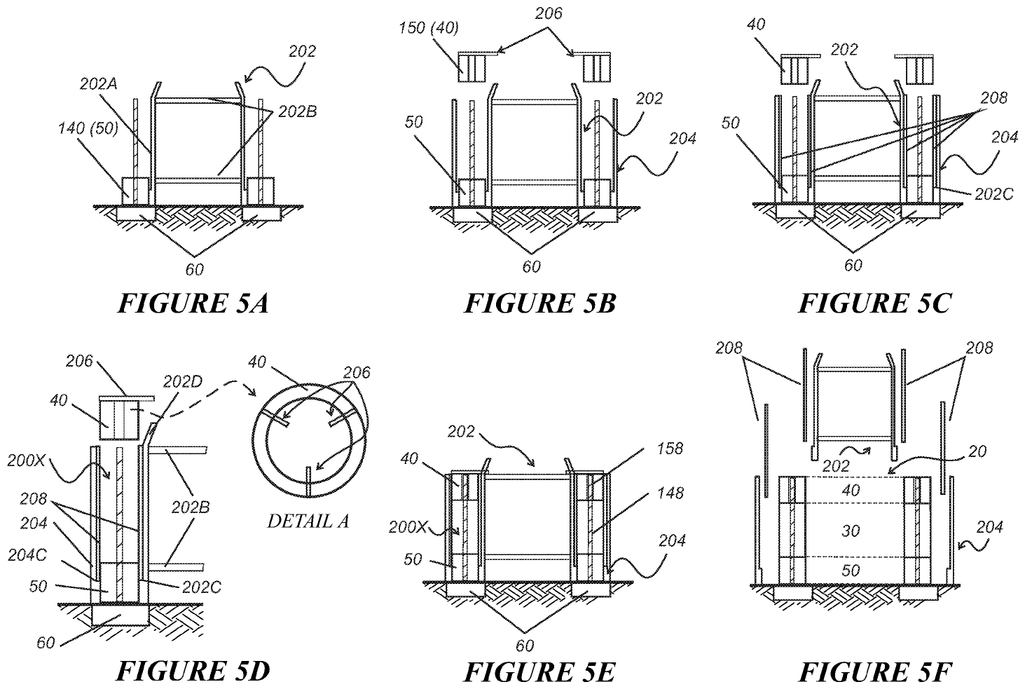

In FIG. 4C two section formworks 200A1, 200B2 have been assembled atop levels 60A1 and 60A2. The section formworks 200A1, 200B2 shown in FIGS. 4C to 4D are merely generalised for illustrative purposes, with more detailed embodiments or configurations of exemplary sections formworks shown and described below with reference to FIGS. 5A to 5F.

Here, the lower seat member 150A1 of the first seat member pair 101A1, is placed at the top of the first section formwork 200A1 (thus becoming upper seat member 40A of the section 20A that will be formed therefrom). Meanwhile, the lower seat member 150B2 of the second seat member pair 101B2, is placed at the top of the second section formwork 200B2 (thus becoming upper seat member 40B of the section 20B that will be formed therefrom).

The intermediate segments 30A and 30B are formed by introducing settable material into the space between seat member pairs 150A1, 140B2 and 150B2, 140C3 (said introduction of said settable material potentially being performed via/through holes of the seat members 150A1, 150B2). The assembly of the section formworks 200A1, 200B2 and formation of the intermediate segments will be described in further detail below.

In FIG. 4D the intermediate segments 30A and 30B are set/cured, and thus the sections 20A, 20B fully formed, with their respective seat members 150A1, 140B2 and 150B2, 140C3 forming part thereof. The section formworks 200A1, 200B2 since being disassembled and removed. FIG. 4D also shows the completed section 20A being lifted or otherwise moved from its location on-ground (by crane or other suitable apparatus) to be placed atop section 20B. In this manner, sections 20A, 20B can be successfully coupled together via match-cast fitting of the match-cast surface 140B (of upper seat member 140B2 of second seat member pair 101B2) with the corresponding match-cast surface 150A (of lower seat member 150B2 of second seat member pair 101B2), these match-cast surfaces 140B, 150A being match-cast at the interface 109 during formation of the second seat member pair 101B2.

While not shown in FIG. 4D, alignment guides or pins 160 (as shown and described with reference to FIG. 2B above) that extend from the match-cast surfaces 140B, 150A can help to interface said sections 20A, 20B. Those skilled in the art will appreciate the wide variety of pins or guides or other alignment means that can be formed as part of a seat member pair 101 or otherwise added thereto after formation/casting, to assist in the downstream match-cast fitting of their surfaces 140B, 150A.

Thus, FIGS. 4A to 4D exemplify the principle advantages of methods described herein for assembling an elongate member 10 from a plurality of sequentially ordered sections 20 positioned in an abutting manner in the elongate direction X of the elongate member 10. Wherein the method involves:
a. casting a plurality of seat member pairs 101 each comprising a lower seat member 150 and an upper seat member 140 by:
   i. casting the lower seat member 150 of each of the plurality of seat member pairs 101 by introducing settable material into a seat member formwork 100,
   ii. casting the upper seat member 140 of each of the plurality of seat member pairs 101 atop the cast lower seat member 150 by introducing settable material into the seat member formwork 100, such that match-cast faces 140B, 150A of each seat member 140, 150 are formed at an interface 109 therebetween so that the seat members 140, 150 of each of the plurality of seat member pairs 101 seat with each other in an abutting manner,
b. separating the seat members 140, 150 of each of the plurality of cast seat member pairs 101,
c. arranging a plurality of section formworks 200, where for each section formwork 200 the upper seat member 140 of a seat member pair 101 is arranged at the bottom thereof and the lower seat member 150 of a subsequent seat member pair 101 is arranged at the top thereof,
d. casting a plurality of intermediate segments 30 between the lower and upper seat members 140, 150 of each section formwork 200 by introducing settable material therein, thereby forming the plurality of sequentially ordered sections 20,
e. arranging the sequentially ordered sections 20 to define the elongate member 10, in sequence such that the match-cast faces 140B, 150A of each of the plurality of seat member pairs 101 are re-joined and seat with each other in an abutting manner to define said elongate member 10.

In this manner, the methods described herein may provide significant advantages in turn-over, cost savings and efficiency when assembling match-cast sections of or for an elongate member 10.

For example, where existing methods require subsequent casting and stacking of sections (thus being limited in speed by the time it takes for concrete to gain enough strength for each section to be handled/lifted), this method instead permits the simultaneous casting of all the required lower seat members 150 of the required seat member pairs 101 on a first day. On the second day, once the lower seat members 150 are fully set, release agent may be applied for the subsequent match-casting of the corresponding upper seat members 140 thereatop. On the third day, the now fully formed seat member pairs 101 may be separated and arranged within section formworks 200. By the end of the fourth day, the intermediate segments 30 of the sections 20 will have been set (by previous introduction of settable material into said section formworks 200, between the seat members arranged therein). Following this, the section formworks 200 may be disassembled, and the completed sections 20 ready for transport, storage or assembly on-site.

Thus, all the required sections 20 for a given elongate member may be ready for assembly within a week, compared to a month when employing known methods of sequential section casting-stacking.

In some embodiments, it will of course be appreciate that one may instead provide a plurality of seat member pairs 101 (each comprising a lower seat member 150 and an upper seat member 140 comprising match-cast surfaces 140B, 150A at an interface 109 therebetween to seat with each other in an abutting manner) previously formed elsewhere rather than cast on-site as described above.

In any case, a large number of sections 20 can be manufactured in a short space of time, enabling a ‘just-on-time’ manufacture principle that does not necessitate the large amount of storage space demanded by the creation of a large number of sections of known/previous methods. Further, work is carried out at ground level (i.e., assembly of seat member formworks 100 and section formworks 200, and casting therein all may be performed on the same levels 60) without the risks associated with working at height (i.e., lifting/stacking of sections in known/previous methods) and thus there is a greatly reduced likelihood of accidents. This can reduce the amount of safety risk associated with such projects, reduce the required labour/handling and thus subsequent costs, and may also reduce the amount of safety documentation and administration often required of large profile construction projects.

Further, it should also be noted that since a large number of sections 20 may be cast in a short space of time, the heights thereof may be greatly reduced, compared to, for example, known methods of sequential section casting-stacking where the long formation time necessitates 5 m high section casting. Thus, since the volume of settable material introduced for formation of intermediate segments 30 of each section 20 is much lower, a much lower hydrostatic pressure is exerted on the section formworks 200. In this way, section formworks 200 described herein may benefit from far simpler and cheaper design and assembly, as their performance requirements are greatly reduced.

Since the heights of sections 20 formed by methods/apparatus described herein are greatly reduced compared to known methods of sequential section casting-stacking, subsequent handling requirements are also greatly reduced. Cranes or other lifting gear required to move/store or lift/assemble sections 20 into an elongate member 10 do not need to be as strong (weight-rated) and thus down-stream costs associated with transport, handling or assembly of sections 20 are also reduced. The same may be said of the seat member and section formworks 100, 200, which, due to their consequent reduced complexity, are also much lighter than formworks required for known sequential section casting-stacking methods, thereby reducing labour and handling costs/times when assembling, disassembling or moving said seat member and section formworks 100, 200. This also means more formworks can be assembled and thus more sections 20 created in a smaller space of time.

An example of the assembly of an embodiment of a section formwork 200 will now be described with more detail in reference to FIGS. 5A to 5F:

In FIG. 5A, after the upper seat member 140 (now lower seat member 50) of a seat member pair 101 has been placed on levels 60 (i.e., what is shown in FIG. 4B), an inner formwork 202 is arranged. This inner formwork 202 comprising vertically oriented posts 202A (so as to form a reinforcing inner cage) about the inner periphery 54 of the lower seat member 50 and horizontally oriented clamps 202B arranged to provide connection of the lower seat member 50 with the posts 202A and general cohesion and integrity of the inner formwork 202.

In FIG. 5B the outer formwork 204 has been arranged, external the outer periphery of the lower seat member 50, meanwhile, the lower seat member 150 (now upper seat member 40) is suspended/hung (by a crane or the like) thereabove, with positioning cleats 206 arranged thereatop.

In FIG. 5C the intermediate segment limits 208 are arranged between the inner and outer formworks 202, 204, in particular, they are seated atop abutments 202C, 204C of the inner formwork posts 202A and outer formwork 204 (as shown in FIG. 5D), and are configured in length to correspond to the top/upper limit of the inner and outer formworks 202, 204, as well as dimensioned appropriately to help with alignment when lowering the upper seat member 50 down into the formwork 200.

In this way, the inner and outer formworks 202, 204, abutments 202C and intermediate segment limits 208 are appropriately dimensioned such that a void 200X formed (as shown in FIG. 5D) therebetween defines the appropriate limits (inner and outer peripheries 34, 36) of the intermediate segment 30 that will be formed therein via introduction of a settable material.

Also shown in FIG. 5D are guides 202D that are diagonally oriented atop of the posts 20A of the inner formwork 202. Detail A of FIG. 5D shows a plan view of the upper seat member 40 where the cleats 206 are angled towards the centre thereof. Thus, the suspended/hung upper seat member 40 can now be lowered into the void 200X, with the cleats 206 interfacing/cooperating with the guides 202D so as to concentrically position the upper seat member 40 correctly as required. While three cleats 206 are shown in Detail A, any number of cleats 206 may be provided to assist in alignment of the upper seat member 40 during lowering thereof. The arranging of the inner and outer formworks 202, 204 atop levels 60 helps to ensure the vertical heights and positions of all the various inner and outer formworks 202, 204, intermediate segment limits 208 and upper and lower seat members 40, 50 is also correct and true.

In FIG. 5E the upper seat member 40 has been fully lowered into position, with the cleats 206 sitting atop the upper horizontally oriented clamp 202B of the inner formwork 202, and thus its upper face 40A correctly aligned with the tops of the inner and outer formworks 202, 204 and intermediate segment limits 208. It can also be seen that due to correct concentric positioning of the upper seat member 40 (by way of the cleats 206 interfacing/cooperating with the guides 202D), the holes 158 and rebars 148 of the seat members are also appropriately positioned relative one another. Settable material may now be introduced, via/through said holes 158, into the void 200X for formation of the intermediate segment 30.

Once the intermediate segment 30 is fully set, the section 20 may be said to be fully formed, in that the upper and lower seat members 40, 50 form permanent features thereof due to their integral connection with the intermediate segment 30 cast therebetween and there against. In FIG. 5F the inner and outer formworks 202, 204 and intermediate segment limits 208 may be disassembled for subsequent extraction of the completed section 20.

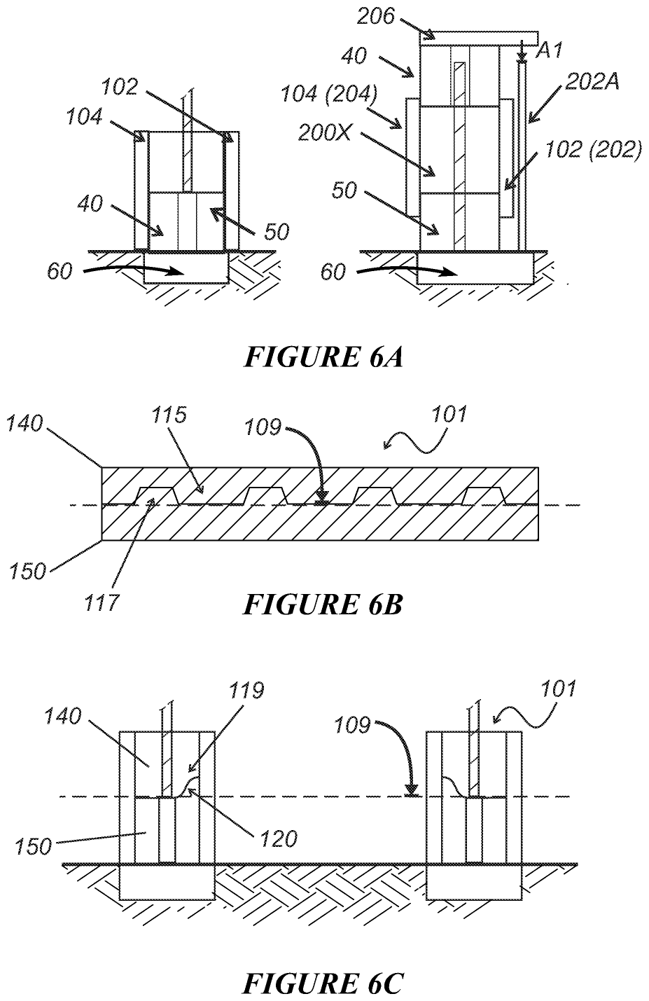

In some embodiments, the inner and outer formworks 102, 104 of a seat member formwork 100 may be repurposed as the inner and outer formworks 202, 204 of a section formwork 200. In such an instance, the intermediate segment 30 of the section 20 formed therefrom will be the same or lesser height as the combined height of the seat member pair 100. This is shown in FIG. 6A, where the inner and outer formworks 102, 104 of a seat member formwork 100 are positioned as inner and outer formworks 202, 204 within a section formwork 200. Posts 202A may still be employed atop the levels 60 to ensure that as the upper seat member 40 is lowered, the cleats 206 thereof contact with said posts 202C to achieve the correct height, as indicated by arrow A1. FIG. 6A shows the upper seat member 40 being lowered for a section formwork 200 where the height of the void 200X (and thus of the intermediate segment 30 that will be cast therein) is less than the total height of the seat member pair, and thus less than the height of the repurposed inner and outer formworks 102 (202), 104 (204). Repurposing parts of the seat member formwork 100 may help decrease time and reduce costs, and will also beneficially result in section formworks 200 of decreased height (and thus decreased cost/complexity since the hydrostatic pressures created by the volume of settable material introduced for formation of the intermediate segment 30 is greatly reduced).

Those skilled in the art will appreciate other configurations of seat member and section formworks 100, 200 that may be used. The example embodiment described with reference to FIGS. 3A to 3C and 5A to 5F above are only one example configurations, and are merely used to provide example of means for correctly positioning, dimensioning and bracing of the seat member and section formworks 100, 200 for formation of a structurally sound seat member pairs 100 and sections 20. Many other means of formwork assembly may be know to those skilled in the art which may be envisaged and may achieve the intended functions and features described herein.

Further, the rebars 148 and holes 158 are also only provided as example configurations of the seat members 40, 50 and sections 20. Other means may or may not be used to provide internal or external reinforcing elements to the sections 20, and introduction of settable material for formation of the intermediate segments 30 may take place via means other than the holes 158 (such as by other vents or apertures provided in the seat members 40, 50 and/or section formwork 200) and may even take place via pumping/injection upwardly into the void 200X at a lower point of the section formwork 200.

In some embodiments, where the sections 20 to be formed are not substantially cylindrical/tubular in form (i.e., slightly tapered for formation of a tapered elongate member 10), flexible section formworks may be employed where the upper and lower peripheries of sections 20 formed thereby can be defined by movable or otherwise reconfigurable inner and outer formworks 202, 204. It will of course be appreciated that the seat member and section formworks 100, 200 described herein may be shaped or otherwise configured depending on the desired outer and inner shapes/cross-sections/peripheries of sections/seat member pairs to be formed therefrom.

It should also be noted that while FIGS. 2A and 2B show sections 20 with intermediate segments 30 being substantially larger in height then their respective seat members 40, 50, other embodiment sections may otherwise be formed where the height of the intermediate segment is larger or smaller relative the height of its seat members. Any suitable proportions may be achieved by methods described herein as desired for a given elongate member application.

FIG. 6B shows an embodiment seat member pair 101 where the upper seat member 140 has castellations 115 cooperating with corresponding apertures 117 of the lower seat member 150 about the interface 109. This may be provided by reconfiguring the seat member formwork 100 and associated method described above in reference to FIGS. 3A to 3C. These castellations 115 and corresponding apertures 117 will have sufficient draft or slope on the projecting surfaces thereof in order that they can be released from one another with-out damage to the seat members 140, 150. Annular ribs are also envisaged as a way of helping to key seat members of a pair together. Such keying helps ensure that there is correct rotational alignment of the seat members and can also help enhance shear strength created by the seat members.

Alternatively, as seen in FIG. 6C, an embodiment seat member pair 101 may be configured such that the upper seat member 140 comprises a female groove 119 cooperating with a corresponding male tongue of the lower seat member 150 about the interface 109. In other embodiments, male and female alignment guides, or other profiling means about the interface 109 may be envisaged by a skilled person in the art to help with coupling together of said seat members of a seat member pair 101.

Said castellations/apertures 115, 117, male and female grooves/tongues 119, 120 or other alignment/profiling means about the interface 109 may also help to enable a shear connection between the match-cast surfaces 140B, 150A of a seat member pair 100, providing further integrity when coupling together the match-cast surfaces 140B, 150A of two sections 20 during assembly of an elongate member 10.

In some embodiments, a lower seat member 50 may be pre-formed or pre-arranged and placed into a seat member formwork 100, followed by subsequent match casting of an upper seat member 40 into a trough, recess or other receptacle of the pre-formed lower seat member 50. In this way, the general casting process may be sped up by the pre-arranging or pre-forming of lower seat members without the use of seat member formworks 100 i.e., they may be pre-built off-site then transported and have seat member formworks 100 arranged around them, thus reducing down-time during drying as only the drying time of the upper seat member 40 needs to be accounted for. Such a pre-formed, pre-built or pre-arranged lower seat member 50 may comprise, for instance, the castellations of FIG. 6B, or the tongue and groove of FIG. 6C, so as provide a trough, recess or other receptacle for receipt/formation of the upper seat member 50 therein, and may be pre-formed, pre-built or pre-arranged from non-settable materials, such as metals etc and the like.

Those skilled in the art may envisage other means of modifying the seat member formation process described in relation to FIG. 3A to 3C to also speed up the overall construction process. For instance, in the example embodiment described above, rather than having the lower seat member 50 pre-formed, pre-built or pre-arranged from non-settable materials, such as metals etc and the like, the lower seat member 50 may instead be cast using a seat member formwork 100 as usual. However, upon its drying, since the trough, recess or other receptacle of the lower seat member 50 acts as a formwork for the upper seat member 40 to be cast therein, the seat member formwork 100 may be removed from the lower seat member 50 prior to or during casting of the upper seat member 40 (since said formwork 100 does not contribute to said casting of said upper seat member 40). In this manner, the seat member formwork 100 may be quickly re-employed to cast another lower seat member 50 so configured as described above, speeding up the overall seat member formation process (since said seat member formwork 100 only needs to be employed for casting/setting of the lower seat member 50).

Once the sections 20 are assembled to form some or all of the elongate member 10, suitable post-tensioning know in the art may be employed to help finalise the integrity and connection of the various sections 20 of an elongate member. Post-tensioning means known in the art that may be employed may include cables routed through ducts formed into the seat members, intermediate segments and the like, or reinforcing means such as cables and the like arranged internal the hollow interior of the elongate member 10 (i.e., external the inner peripheries of the sections 20).

1. An elongate member constructed of a stacked sequence of adjacent sections, the elongate member comprising:
at each interface of adjacent sections:
(a) a lower seat member of an upper more of said adjacent sections, and
(b) an upper seat member of a lower more of said adjacent sections,
said upper and lower seat members at each interface having been match-cast as a seat member pair and seated with each other in the same relative position as the relative position the seat member pair was match-cast in.

2. An elongate member as claimed in claim 1, wherein each said section further comprises a segment intermediate of and spanning between its respective upper and lower seat members.

3. An elongate member as claimed in claim 2, wherein the segment intermediate of each section is of a cast settable material.

4. An elongate member as claimed in claim 2 or 3, wherein the segment intermediate of each section is of a cast settable material match cast with its respective upper and lower seat members.

5. An elongate member as claimed in anyone of claims 2 to 4, wherein the segment of each section comprises of set concrete poured against and spanning between respective upper and lower seat members of said section.

6. An elongate member as claimed in anyone of claims 1 to 5, wherein each seat member pair comprises a lower seat member and an upper seat member formed by casting the upper seat member of each seat member pair atop the lower seat member thereof by introducing settable material into a seat member formwork.

7. An elongate member as claimed in anyone of claims 1 to 6, wherein each seat member pair comprises a lower seat member and an upper seat member formed by:
i. casting the lower seat member of each of the plurality of seat member pairs by introducing settable material into a seat member formwork,
ii. casting the upper seat member of each of each seat member pairs atop the cast lower seat member by introducing settable material into the seat member formwork.

8. An elongate member as claimed in anyone of claim 6 or 7, wherein the match-cast faces of the upper and lower seat members of each seat member pair are formed at an interface therebetween so that the upper and lower seat members of each seat member pair can seat with each other in an abutting manner.

9. An elongate tower assembled as a stack of a plurality of sections on top of each other, the tower comprising of at least two adjacent said sections that at their interface comprise of a first seat member of a first of said adjacent sections and a second seat member of a second of said adjacent sections, the first seat member and the second seat member at their interface having been match-cast as a seat member pair and seated with each other in the same relative position as the relative position the seat member pair was match-cast in.

10. An elongate tower as claimed in claim 9, wherein said first of said adjacent sections comprises, match cast against and projecting in the elongate direction from the first seat member, a cast intermediate segment.

11. An elongate tower as claimed in claim 9 wherein said second of said adjacent sections comprises, match cast against and projecting in the elongate direction from the second seat member, a cast intermediate segment.

12. A method for assembling an elongate member of a plurality of sequentially ordered sections positioned in an abutting manner in the elongate direction of the elongate member, wherein the method comprises:
a. forming a plurality of seat member pairs each comprising a lower seat member and an upper seat member by:
i. casting the upper seat member of each seat member pair atop the lower seat member thereof by introducing settable material into a seat member formwork, such that match-cast faces of the upper and lower seat members of each seat member pair are formed at an interface therebetween so that the upper and lower seat members of each seat member pair can seat with each other in an abutting manner,
b. separating the upper seat member of each seat member pair from the lower seat member thereof,
c. arranging a plurality of section formworks, where for each section formwork the upper seat member of a seat member pair is arranged at the bottom thereof and the lower seat member of a subsequent seat member pair is arranged at the top thereof,
d. casting an intermediate segment against and between the lower and upper seat members of each section formwork by introducing settable material therein, thereby forming the plurality of sequentially ordered sections,
e. arranging the sequentially ordered sections to define the elongate member, in sequence such that the match-cast faces of each of seat member pair are re-joined and seat with each other in an abutting manner to define said elongate member.

13. A method as claimed in claim 12, wherein the method also comprises casting the lower seat member of each of the plurality of seat member pairs by introducing settable material into said seat member formwork.

14. A method as claimed in claim 12 or 13, wherein the method also comprises, immediately before step (i), casting the lower seat member of each of the plurality of seat member pairs by introducing settable material into said seat member formwork.

15. A method for assembling an elongate member from a plurality of sequentially ordered sections positioned in an abutting manner in the elongate direction of the elongate member, wherein the method comprises:
a. providing a plurality of seat member pairs each comprising a lower seat member and an upper seat member comprising match-cast surfaces at an interface therebetween to seat with each other in an abutting manner,
b. arranging a plurality of section formworks, where for each section formwork the upper seat member of a seat member pair is arranged at the bottom thereof and the lower seat member of a subsequent seat member pair is arranged at the top thereof,
c. casting an intermediate segment against and between the lower and upper seat members of each section formwork by introducing settable material therein, thereby forming the series of sequentially ordered sections,
d. arranging the sequentially ordered match-cast sections to define the elongate member, in a sequentially ordered sequence such that the match-cast surfaces of each of the plurality of seat member pairs are re-joined and seat with each other in an abutting manner to define said elongate member.

16. A section of or for an elongate member constructed from a sequentially ordered series of said sections positioned in an abutting manner in the elongate direction of the elongate member, said section comprising:
an intermediate segment formed by introducing a settable material into a void of a section formwork defined between a lower seat member and an upper seat member arranged within and/or at opposed ends of said section formwork, the seat members forming part of the section once said intermediate segment is set,
wherein the lower and upper seat members each comprise outwardly facing match-cast surfaces configured to seat in an abutting manner with corresponding outwardly facing match-cast surfaces of the seat members of another section or sections of said series of sections, said outwardly facing match-cast surfaces thereby defining opposing ends of the section so as to permit its sequential abutment with another section or sections of said series of sections.

17. A method of casting a plurality of seat member pairs each comprising a lower seat member and an upper seat member for assembling an elongate member of a plurality of sequentially ordered sections positioned in an abutting manner in the elongate direction of the elongate member, wherein the method comprises by:
i. casting the lower seat member of each of the plurality of seat member pairs by introducing settable material into a seat member formwork,
ii. casting the upper seat member of each of each seat member pairs atop the cast lower seat member by introducing settable material into the seat member formwork, such that match-cast faces of the upper and lower seat members of each seat member pair are formed at an interface therebetween so that the upper and lower seat members of each seat member pair can seat with each other in an abutting manner.

18. A method as claimed in claim 17, wherein the method further comprises separating the upper seat member from the lower seat member of each cast seat member pair.

19. A method of constructing an elongate member from a plurality of abutting sections, the method comprising:
a. forming a first seat member by casting a settable material against a second seat member to, at the interface of the first seat member and second seat member, define a match-cast surface of each of said first seat member and second seat member, and
b. forming a first of said sections by match casting against and projecting in the elongate direction away from the first seat member, a first section segment using a settable material, with the match cast surface of said first seat member presented at a first end of said first section, and
c. forming a second of said sections by match casting against and projecting in the elongate direction away from the second seat member, a second section segment using a settable material, with the match cast surface of said second seat member presented at a first end of said second section,
d. stacking the first section against the second section with the match cast surface of the first seat member abutting the match cast surface of the second seat member.

20. A method as claimed in claim 19, wherein the first seat member is formed by casting a settable material on top of the second seat.

21. A method as claimed in claim 19 or 20, wherein the first of said sections is formed, by match casting on top and projecting upwardly and in the elongate direction away from the first seat member, a first section segment using a settable material, with the match cast surface of said first seat member presented at the first end, being the bottom end, of said first section.

22. A method as claimed in claims 19 to 21, wherein the second of said sections is formed, by match casting on top and projecting upwardly and in the elongate direction away from the second seat member, a second section segment using a settable material, with the match cast surface of said second seat member presented at the first end, being the bottom end, of said second section.

23. A method as claimed in claims 19 to 21, wherein the second of said sections is formed, by match casting against and projecting downwardly and in the elongate direction away from the second seat member, a second section segment using a settable material, with the match cast surface of said second seat member presented at the first end, being the top end, of said second section.

24. A method a claimed in claim 23, wherein the stacking occurs in a vertical direction.

25. A wind tower constructed from a plurality of sections as claimed in claim 16.
